(19) United States
(12) Patent Application Publication
(10) Pub. No.: US 2011/0004627 A1
(43) Pub. Date: Jan. 6, 2011

(54) DASHBOARD FOR BUSINESS PROCESS MANAGEMENT SYSTEM

(75) Inventors: Mateo Almenta Reca, San Francisco, CA (US); Nicolas Damonte, Ramos Mejia (AR)

Correspondence Address: FLIESLER MEYER LLP, 650 CALIFORNIA STREET, 14TH FLOOR, SAN FRANCISCO, CA, 94108, US

(73) Assignee: ORACLE INTERNATIONAL CORPORATION, Redwood Shores, CA (US)

(21) Appl. No.: 12/496,522

(22) Filed: Jul. 1, 2009

(51) Int. Cl. G06F 17/30; G06F 3/048; G06Q 10/00; G06F 17/00

(52) U.S. Cl. 707/778; 715/771; 715/234; 705/1.1; 707/912; 707/955; 707/812

(57) ABSTRACT

A Business Process Management (BPM) system can allow for creating and executing business processes. The BPM system can produce historical activity data. The historical activity data can be sent to a database for storage from an in memory cache. The BPM system can include a BPM dashboard to display the historical activity data. The BPM dashboard can obtain the historical activity data from the in memory cache before it is sent to the database.

### FIELD OF THE INVENTION

The current invention relates generally to business process management software tools and design.

### BACKGROUND

In recent years, Business Process Management (BPM) systems have become more and more widely used among various organizations. A business enterprise typically desires to integrate all of its data and processes into a single and unified system. For example, an organization may automate a business process by having a computer perform certain activities of the business, such as receiving a sales order, sending a notification to a client, or reminding a human participant of work that needs to be performed.

While automation of such business processes has posed a number of difficulties, software BPM systems have become ever increasingly important solutions to many organizations. By implementing software BPM suites, enterprises are becoming more and more able to increase productivity, performance, profits and decrease inefficiency due to various factors.

### BRIEF DESCRIPTION OF THE DRAWINGS

FIG. 1 shows an exemplary dashboard screen.

FIG. 2 shows an exemplary dashboard system of one embodiment.

FIG. 3 shows an exemplary operation of a dashboard of one embodiment.

FIG. 4 shows a business process design page of one embodiment.

### DETAILED DESCRIPTION

Business Process Management (BPM) can be an integrated solution for creating, executing and optimizing business processes. Business Process Management can enable collaboration between business and IT through modeling and design tools that ensure efficient iterations by each participant in the business process lifecycle. Business analysts can design, document and run simulations of a complete process without involving Information Technology (IT). When the process fulfills the business specifications in simulation, it is directed to IT who then implements the necessary connectivity to existing IT systems, creates the rules that drive the process and deploys the process.

User interfaces for human interaction with business processes can be generated automatically and provide as standards-based portlets. Both real-time and historical process data can be collected by the server and made available through interactive dashboards, ensuring that activity data can be tracked by the business and processes can be continuously optimized.

Business Process Management can leverage Service Oriented Architecture (SOA) infrastructure by enabling the orchestration of services deployed in the service network, and by allowing people to interact with those services through managed work processes. Business Process Management can also integrate directly with a portal and Web experience frameworks to provide a richer user experience for process users. This integration can deliver a powerful combination of Business Process Management and human collaboration tools that support the wider balance of structured and unstructured work patterns.

Business Process Management can also be well-suited for deployments that do not yet involve a service infrastructure. Enterprises often enjoy the benefits of Business Process Management without first service-enabling their existing systems simply by using a common system for modeling and documenting work processes and activities, and also by using the underlying system connectivity capabilities within the product.

As a general overview of BPM systems, the term business process management (BPM) can define the different activities of an organization or a business group used to implement and complete specific processes. After a process is in place, additional steps can be performed to improve and optimize its flow and performance. In broad terms, the main activities that constitute business process management can be divided into four top categories: design, implementation, execution, and monitoring. A business process management system can provide a collection of software tools that together can be used to model, implement, run, monitor, and optimize a business process.

Business processes are a part of the day-to-day operations and services of any corporation. Some examples of processes include applying for a house loan (e.g. loan origination process), starting a mobile phone service (account initiation process), hiring a new employee (employee on-boarding process), building a new jet engine (parts and assembly process) as well as countless other processes performed by enterprises and organizations in order to accomplish specific goals. Processes can range from very simple to highly complex and sophisticated, involving numerous decisions, tasks and activities.

The term process, as used in this specification, is a set of activities which collectively realize a business objective. The business process can be thought of as the process-driven application, with the model and all the integration, presentation, and logic. A typical process includes a logical flow with associated roles and systems. It is modeled, tested, and simulated within the process designer component of the business process management (BPM) system. Each process can have associated therewith a process definition, which provides the representation of the business process in a form that supports automated manipulation, such as modeling or enactment by a process execution engine or a web service. The process definition contains a set of related activities and their relationships, as well as criteria to indicate the start and termination of the process, and information about the individual activities, such as roles, systems, and user interface forms. In one embodiment, the process definition is contained in an extensible markup language (XML) file and can be read, executed, monitored and manipulated by a process designer, execution engine or other components of the BPM system.

Business process can be designed with a process designer and executed with a BPM execution engine, along with client applications, management tools, and other components, to interact with it. All of these modules can be included within the BPM system. Additionally, if a business process invokes web services, reads from a custom database, or uses Enterprise JavaBeans (EJBs), it may be necessary to ensure that these services are available in order to enable the application to work as expected.

In one embodiment, a process includes a set of activities, where each activity represents a single piece of work that forms a different step of the process. The various steps are linked together through transitions. Activities can be user-interactive or they can be totally automated. An activity can also include a series of tasks to complete that activity. For user-interactive activities, a role can be defined to identify which user is allowed to interact with the process at each point.

When a business process is executed by an engine, it forms a specific process instance. A process instance is the representation of a single enactment of a process, or an activity within a process, including its associated data. In one embodiment, each instance represents a separate thread of execution of the process or activity, and will have its own internal state and externally visible identity, which may be used, for example, to record or retrieve audit data relating to the individual enactment, such as a particular purchase order number, as opposed to the general purchase order process. Instances can start at the Begin activity of the process and finish in the End activity. The path the instances take can depend entirely on the data of the instance and the external environment.

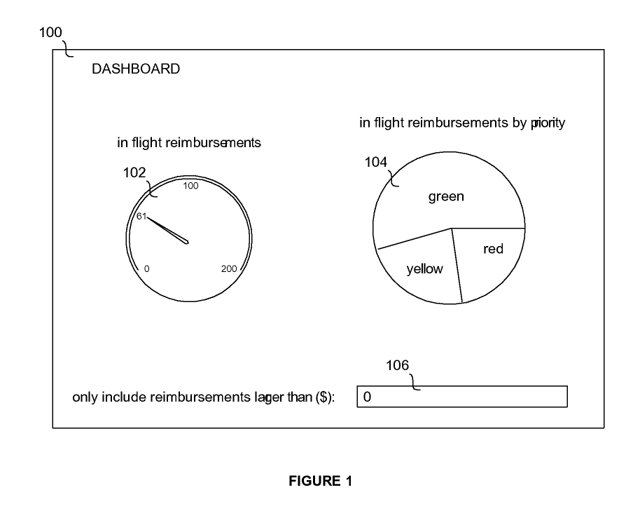

As shown in FIG. 1, a BPM Dashboard can provide IT administrators and business users with historical activity data for business processes running in a BPM Enterprise Server. The BPM dashboard can enable business users to track performance and workload against key performance indicators and it provides an audit trail for tracking and documenting compliance with service level agreements and regulations. Pre-built process activity dashboards for the most common usage scenarios can be provided. In one embodiment, business users can drill down from an aggregate Organizational Unit (OU) level to process level and then finally to activity granularity.

In the example of FIG. 1, the dashboard screen 100 shows the reimbursements in progress for an exemplary business process. Dial 102 shows the number of in-flight reimbursements and pie chart 104 illustrates the priority levels of the in-flight reimbursements.

The user can enter data to filter the display. In the example of FIG. 1, the user can use input area 106 to indicate the minimum reimbursement value shown by dashboard display 100. When the user inputs a new minimum value, dial 102 and chart 104 are automatically updated. The dashboard screen 100 can be used by executives to get a high level picture of the different parts of the business process system, especially those parts that are waiting on employees to do an action.

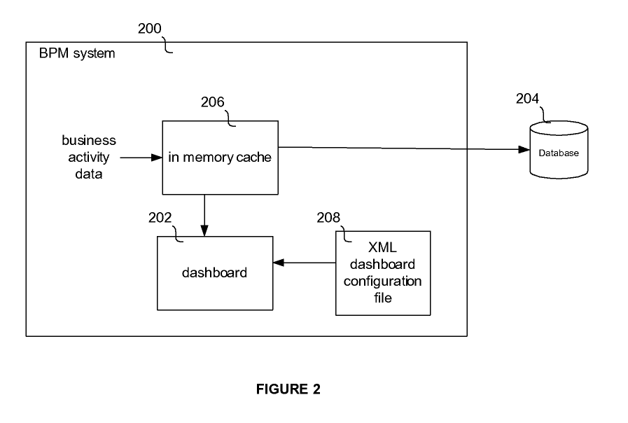

One embodiment of a BPM system 200 using a dashboard 202 is shown in FIG. 2. The BPM system 200 can allow for creating and executing business processes. The BPM system 200 can also produce historical activity data. The historical activity data can be sent to a database 204 for storage from an in-memory cache 206. The BPM system 200 can include a BPM dashboard 202 to display the historical activity data. The BPM dashboard 202 can obtain the historical activity data from the in-memory cache 206 before it is sent to the database.

Obtaining the historical activity data from the in-memory cache can increase the freshness of the data. The historical activity data need not be sent to the database before it is displayed in a dashboard.

The dashboard 202 can be configurable using XML 208. The XML can indicate the types of historical data to be used include, as well as the type of charts for the dashboard display.

The dashboard can use graphical charts, such as pie charts of the historical activity data. Users can configure what data is shown in a chart. A user can set, for example, what historical activity data is to be displayed and how it is to be displayed. In addition, predefined dashboard displays can be used.

The business activity data that is stored in the cache and database can be configured. For example, the user can define different metrics or other data that is to be stored in the database or otherwise made available to the dashboard.

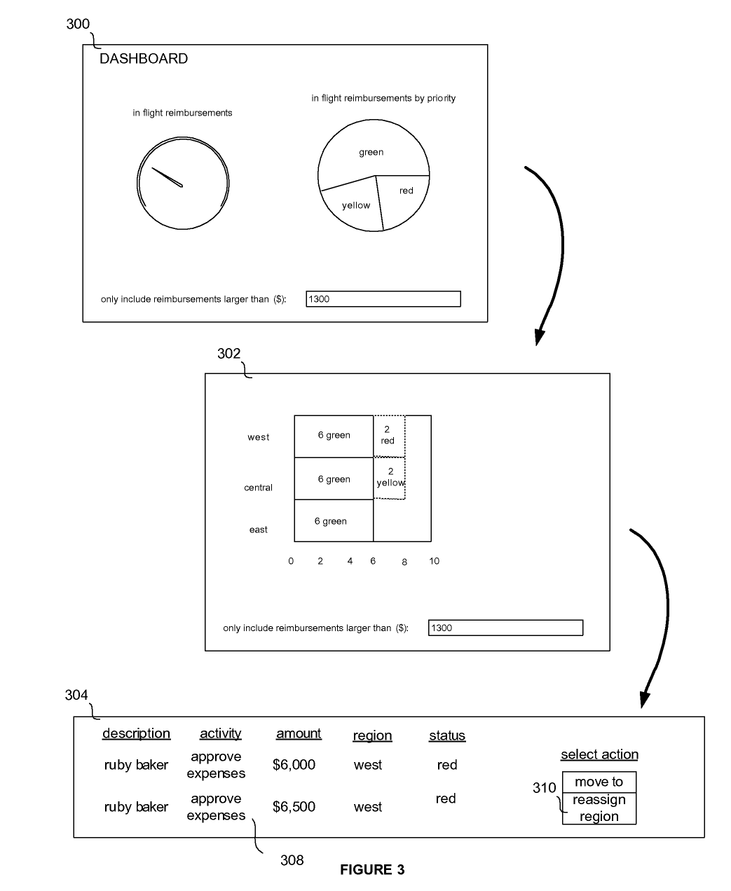

In one embodiment, as shown in FIG. 3, the BPM dashboard 300 allows for the clicking down to dashboard displays 302 with more detail and to displays 304 that allow the user to modify a business process.

Clicking on a chart can produce a display with details about one of the components of the chart. For example, clicking on the chart can produce a display with details about an employee's business process instances. Clicking on the display can also send the user to a screen 304 with a list based report 308.

In the example of the screen 304 of FIG. 3, a “selected activity” pull down menu 310 can allow the selection of an action on the business process instances. In this example, a “reassign region” action can allow for in-flight reimbursements to be reassigned to different regions to speed up the processing of the reimbursements. Since the actions are easily accessed using the dashboard, it makes it easier for managers to manage the business process.

In one embodiment, a Business Activity Monitor can provide information to a database, create Dashboards, and configure Business Activity Monitoring.

Business Activity Monitoring (BAM) can allow for the storing, analyzing, and displaying statistics about your business process execution. The Business Process Monitor can provide information about process instance performance and process workload. This information can be used to present almost real-time business processes metrics. These can be used to analyze and then improve or adapt business processes based on real-world conditions.

In one embodiment, to store and present this information, the Business Activity Monitor can contain a database, SQL queries and dashboards.

Business Activity Monitoring data can be stored within a database. This information can be stored internally as part of an embedded process execution engine database. Alternatively, an external database can be configured to function as the database.

Queries to access the information stored in the database can be used. These queries can be contained within a BPM Object Method. A Dashboard can be created using a wizard. The wizard can automatically create queries based on the type of Dashboard template chosen. These queries and dashboards can be customized.

Dashboards can allow for the display of business activity information in a meaningful and useful way. Dashboards also allow users to drill down from a general view of a process to more specific information such as an order or claim.

Real-time dashboards can be tested using data generated by an embedded Process Execution Engine.

The database can be used to store information about your business processes.

In one embodiment, the database can store the following types of information about a process:
1. Workload
2. Task Performance
3. Process Performance

The database can be populated with the information generated by auditing events. Auditing events generation can be enabled for the whole process, for a subset of activities or for a particular activity.

When creating a Project variable, it can be defined as a Business Indicator variable. This allows the variable to be stored in the database.

When a Business Indicator variable is added to a process, a column can be added to the following database tables: Workload, Task Performance and Process Performance. The name of the column can include the Business Indicator name.

If a business dimension is defined, the workload table can contain one row for each possible value of this business dimension present in the process. Each of these rows can show the quantity of instances that match that business dimension.

When a measurement business variable is defined the sum of this variable's value for all in-flight can be stored into workload table. If business dimensions were defined as well, then this sum can be divided into as many rows as business dimension values present in flight instances.

Task performance table stores one row for each instance that completes an activity. Each of these rows contains the value of dimensions and measurements at the time the instance completed the activity.

In a similar way, process performance table stores one row for each instance that gets to the end activity. Each of these rows can contain the value of dimensions and measurements at the time the instance completed the whole process.

Dashboards can be created using predefined templates. To create a Predefined Dashboard in one embodiment:
1. Select the type of template you want to use. You can select more than one template if necessary.
2. Select the Process whose information you want to report.
3. Select the Role you want to allow to view the information.

Anyone assigned to this role is able to view the dashboard.

Dashboards can be created for each of the template you selected. Dashboard Global activities for each dashboard can be added to the process.

An exemplary database configuration is shown in Appendix 1.

A BPM Designer component can be the business analyst's design environment. It can enable the creation of any type of process by dragging and dropping process elements onto swim-lanes. A BPM Designer component can have support for Business Process Modeling Notation (BPMN) and UML modeling standards using “themes” that users can apply to seamlessly switch between different views. Business analysts can design and simulate a process inside the BPM Designer component without writing any code or having to work with IT. This includes browsing the organizational structure in external enterprise directories and mapping enterprise roles to process roles. Once the process is considered complete from a business perspective it can be directed to IT for completion and deployment. The project model can support a seamless iterative collaboration between business and IT.

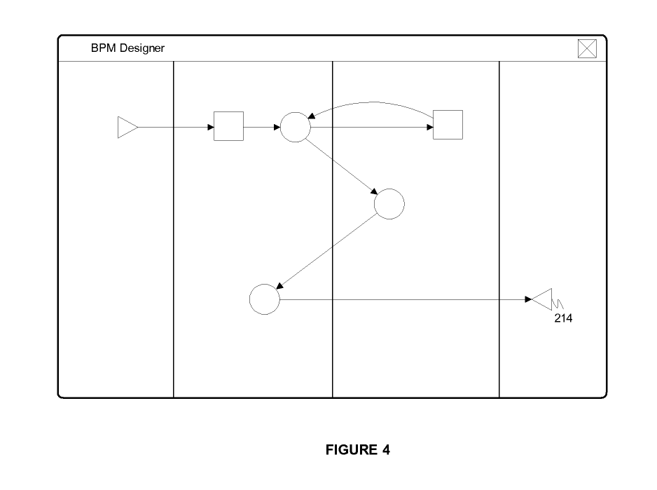

FIG. 4 shows an exemplary BPM design screen.

A BPM Enterprise Server can orchestrate all resources part of each process—people, organizations, applications and systems—coordinating the proper sequence, enforcing business rules, and auditing each step to ensure flawless process execution, escalation and exception management.

A BPM workspace can provide a high performance workspace for business process participants interacting with process activities and workflows. Activities that require human interaction can be surfaced to the Web in an intuitive work list manager, without the need for manual Web page design or coding. Participants can access and manipulate tasks according to their assigned roles and responsibilities. The user interface components of a BPM Workspace can be exposed as standards-based JSR 168 portlets that can be consumed by any portal platform supporting this standard.

Embodiments of the present invention can include computer-based methods and systems which may be implemented using conventional general purpose or a specialized digital computer(s) or microprocessor(s), programmed according to the teachings of the present disclosure. Appropriate software coding can readily be prepared by programmers based on the teachings of the present disclosure.

Embodiments of the present invention can include a computer readable medium, such as computer readable storage medium. The computer readable storage medium can have stored instructions which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory or any media or device suitable for storing instructions and/or data. The present invention can include software for controlling both the hardware of a computer, such as general purpose/specialized computer(s) or microprocessor(s), and for enabling them to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer-implemented method for transmitting the code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A system for providing dashboards in a process management environment, the system comprising:
one or more process engines that execute process instances, wherein execution of the process instances produces runtime activity data;
an in memory cache that stores the runtime activity data collected from the one or more process engines before sending the runtime activity data to a database; and
a dashboard that obtains the runtime activity data from the in memory cache during the execution of the process instances and dynamically renders the runtime activity data on a graphical interface, wherein the dashboard is used to receive a modification from a user at runtime and automatically modifies a process according to the modification.

2. The system of claim 1, wherein the dashboard is configurable.

3. The system of claim 2, wherein the configuration of the dashboard uses XML.

4. The system of claim 1, wherein the dashboard uses graphical charts of historical activity data.

5. The system of claim 4, wherein at least one of the charts shows what users currently have actions to do.

6. The system of claim 5, wherein the at least one chart is a pie chart.

7. The system of claim 4, wherein a user can configure what data is shown in a chart.

8. The system of claim 1, wherein a user can configure the business activity data that is stored in the cache and database.

9. A computer readable storage medium having instructions stored thereon, which when executed by one or more processors, cause the one or more processors to perform the steps of:
executing one or more process instances and thereby causing runtime activity data to be produced;
capturing the runtime activity data associated with the process instances and storing the runtime activity data into an in-memory cache before the data is sent to the database;
obtaining the runtime activity data from the in-memory cache during the execution of the process instances;
rendering a dashboard that dynamically displays the runtime activity data on a graphical interface; and
receiving at least one modification by way of the dashboard and modifying a process at runtime according to the modification.

10. The computer readable storage medium of claim 9, wherein the dashboard is configurable by way of a configuration file such that the computer reads the configuration file and renders the dashboard in accordance with preferences stored thereon.

11. The computer readable storage medium of claim 10, wherein the configuration of the dashboard uses XML.

12. The computer readable storage medium of claim 9, wherein the dashboard uses graphical charts of historical activity data.

13. The computer readable storage medium of claim 12, wherein at least one of the charts shows what users currently have actions to do.

14. The computer readable storage medium of claim 12, wherein the at least one chart is a pie chart.

15. The computer readable storage medium of claim 12, wherein a user can configure what data is shown in a chart.

16. The computer readable storage medium of claim 9, wherein a user can configure the business activity data that is stored in the cache and database.

17.-20. (canceled)

21. A method for providing dashboards in a process management environment, said method comprising:
executing one or more process instances and thereby causing runtime activity data to be produced;
capturing the runtime activity data associated with the process instances and storing the runtime activity data into an in-memory cache before the data is sent to the database;
obtaining the runtime activity data from the in-memory cache during the execution of the process instances;
rendering a dashboard that dynamically displays the runtime activity data on a graphical interface; and
receiving at least one modification by way of the dashboard and modifying a process at runtime according to the modification.

22. The method of claim 21, wherein the dashboard allows for the clicking down to multiple dashboard displays with additional details.

23. The method of claim 21, wherein clicking on a chart can produce a display with details about one of the components of the chart.

24. The method of claim 21, wherein clicking on the chart produces a display with details about an employee's business process instances.

25. The method of claim 21, wherein clicking down sends the user to a screen with a list based report.
